(19) United States
(12) Patent Application Publication
(10) Pub. No.: US 2009/0146988 A1
(43) Pub. Date: Jun. 11, 2009

(54) ACTIVE MATRIX ELECTROLUMINESCENT DISPLAY DEVICE WITH TUNABLE PIXEL DRIVER

(75) Inventors: Mark T. Johnson, Veldhoven (NL); Adrianus Sempel, Waalre (NL); William A. Steer, Stanmore (GB)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONIC, N.V., EINDHOVEN (NL)

(21) Appl. No.: 10/596,848

(22) PCT Filed: Jan. 4, 2005
(86) PCT No.: PCT/IB05/50023

§ 371 Date: Jun. 27, 2006

(30) Foreign Application Priority Data
Jan. 6, 2004 (GB) 0400105.3

(51) Int. Cl. G09G 5/00; G09G 3/30

(52) U.S. Cl. 345/214; 345/76

(57) ABSTRACT

Driver circuitry of each pixel provides pixel drive currents to respective LED display elements of the pixels of a display. An output transistor arrangement for each column drive circuit within a pixel has a plurality of output transistors (70, 72, 74) in parallel, and one or more of these are selected in order to provide desired output characteristics. Thus, the output of each column drive circuit can be tuned to provide desired output characteristics. In order to select an output transistor, fusible links of non selected transistors may be broken, or further transistors may connect selected transistors to a gate control line while non-selected transistors are connected to a de-select line.

This invention relates to current-addressed display devices, particularly active matrix display devices having thin film switching transistors associated with each pixel.

Matrix display devices employing electroluminescent, light-emitting, display elements are well known. The display elements may comprise organic thin film electroluminescent elements, for example using small molecule or polymer organic materials, or else light emitting diodes (LEDs) using traditional III-V semiconductor compounds. Recent developments in organic electroluminescent materials, have demonstrated their ability to be used practically for video display devices. These organic materials typically comprise one or more layers sandwiched between a pair of electrodes, one of which is transparent and the other of which is of a material suitable for injecting holes or electrons into the polymer layer.

The organic material can be fabricated using a CVD process, or by a spin coating technique in the case of a solution of a soluble conjugated polymer. Ink-jet printing may also be used. Organic electroluminescent materials exhibit diode-like I-V properties, so that they are capable of providing both a display function and a switching function, and can therefore be used in passive type displays. Alternatively, these materials may be used for active matrix display devices, with each pixel comprising a display element, a switching device, and addressing and storage elements for controlling the current through the display element.

Display devices of this type have current-driven display elements, so that a conventional, analogue drive scheme involves supplying a controllable current to the display element. It is known to provide a current source transistor as part of the pixel configuration, with the gate voltage supplied to the current source transistor determining the current through the display element. A storage capacitor holds the gate voltage after the addressing phase.

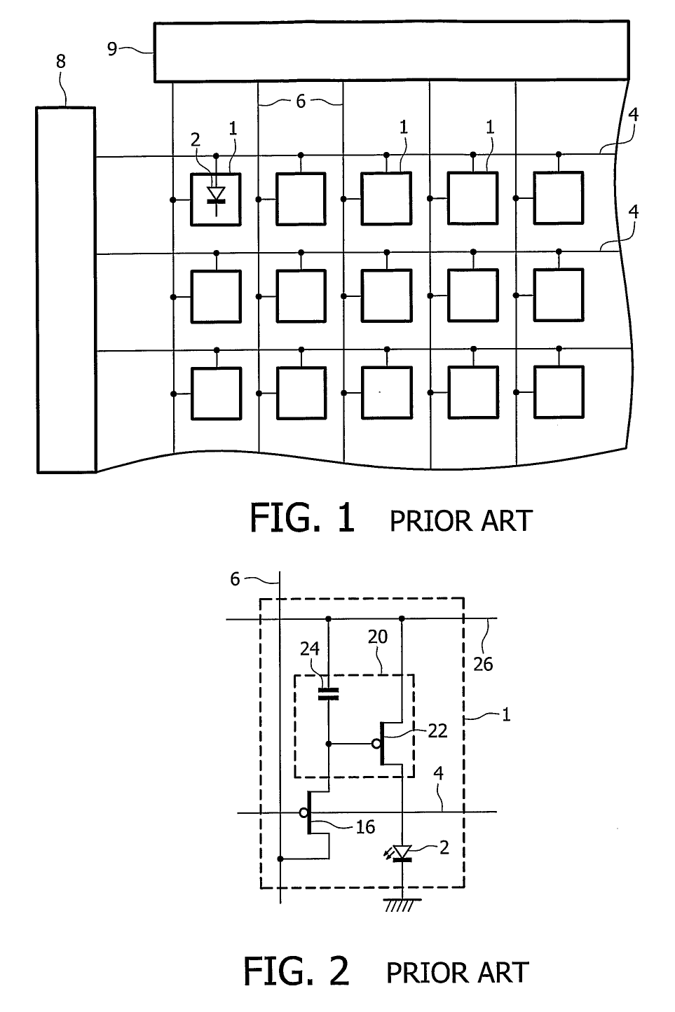

FIG. 1 shows a known active matrix addressed electroluminescent display device. The display device comprises a panel having a row and column matrix array of regularly-spaced pixels, denoted by the blocks 1 and comprising electroluminescent display elements 2 together with associated switching means, located at the intersections between crossing sets of row (selection) and column (data) address conductors 4 and 6. Only a few pixels are shown in the Figure for simplicity. In practice there may be several hundred rows and columns of pixels. The pixels 1 are addressed via the sets of row and column address conductors by a peripheral drive circuit comprising a row, scanning, driver circuit 8 and a column, data, driver circuit 9 connected to the ends of the respective sets of conductors.

The electroluminescent display element 2 comprises an organic light emitting diode, represented here as a diode element (LED) and comprising a pair of electrodes between which one or more active layers of organic electroluminescent material is sandwiched. The display elements of the array are carried together with the associated active matrix circuitry on an insulating support. At least one of the cathodes or the anodes of the display elements are formed of transparent conductive material. The support can be of transparent material such as glass and the electrodes of the display elements 2 closest to the substrate may consist of a transparent conductive material such as ITO so that light generated by the electroluminescent layer is transmitted through these electrodes and the support so as to be visible to a viewer at the other side of the support. Also, light may be emitted into the other direction depending on the transparency of the associated conductive material layer. A non-transparent substrate may also be used. Typically, the thickness of the organic electroluminescent material layer is between 10 nm and 200 nm. Typical examples of suitable organic electroluminescent materials which can be used for the elements 2 are known and described in EP-A-0 717446. Conjugated polymer materials as described in WO96/36959 can also be used.

FIG. 2 shows in simplified schematic form a known pixel and drive circuitry arrangement for providing voltage-programmed operation. Each pixel 1 comprises the LED display element 2 and associated driver circuitry. The driver circuitry has an address transistor 16 which is turned on by a row address pulse on the row conductor 4. When the address transistor 16 is turned on, a voltage on the column conductor 6 can pass to the remainder of the pixel. In particular, the address transistor 16 supplies the column conductor voltage to a current source 20, which comprises a drive transistor 22 and a storage capacitor 24. The column voltage is provided to the gate of the drive transistor 22, and the gate is held at this voltage by the storage capacitor 24 even after the row address pulse has ended and the switch 16 is turned off. The drive transistor 22 draws a current from the power supply line 26.

The drive transistor 22 in this circuit is implemented as a PMOS TFT, so that the storage capacitor 24 holds the gate-source voltage fixed. This results in a fixed source-drain current through the transistor, which therefore provides the desired current source operation of the pixel.

To date, the majority of active matrix circuits for LED displays have used low temperature polysilicon (LTPS) TFTs. The threshold voltage of these devices is stable in time, but varies from pixel to pixel in a random manner. This leads to unacceptable static noise in the image.

Many circuits have been proposed to overcome this problem. In one example, each time the pixel is addressed the pixel circuit measures the threshold voltage of the current-providing TFT to overcome the pixel-to-pixel variations. This technique has been proposed for voltage-addressed pixels.

It has also been recognised that a current-programmed pixel can reduce or eliminate the effect of transistor variations across the substrate. For example, a current-programmed pixel can use a current mirror to sample the gate-source voltage on a sampling transistor through which the desired pixel drive current is driven. The sampled gate-source voltage is used to address the drive transistor. This partly mitigates the problem of uniformity of devices, as the sampling transistor and drive transistor are adjacent to each other over the substrate and can be more accurately matched to each other. Another current sampling circuit uses the same transistor for the sampling and driving, so that no transistor matching is required, although additional transistors and address lines are required.

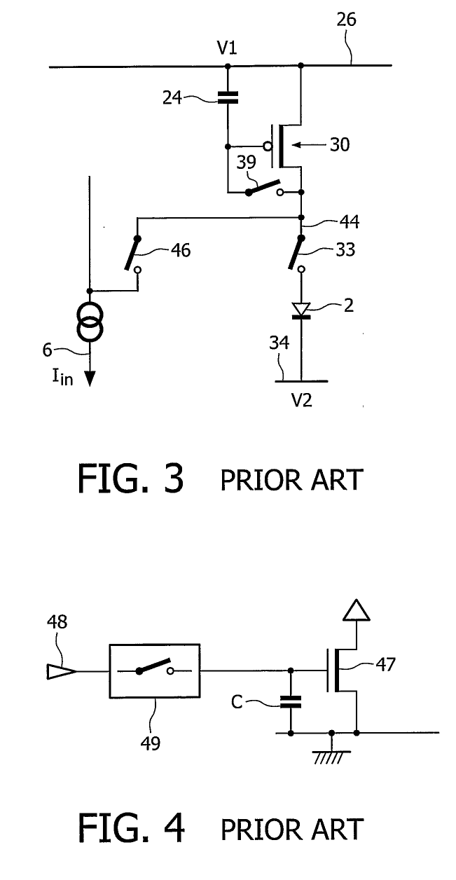

FIG. 3 shows schematically the current mirror pixel circuit which uses the same transistor for sampling and driving. The circuit comprises a drive transistor 30, more particularly a p-channel FET, whose first current—carrying (source) terminal is connected to the supply line 26 and whose second current—carrying (drain) terminal is connected, via a switch 33, to the anode of the display element 2. The cathode of the display element is connected to a second supply line 34, which in effect is constituted by the continuous electrode layer held at a fixed reference potential. In some technologies, the functions of the anode and cathode can be reversed.

The gate of the drive transistor 30 is connected to the supply line 26, and hence the source electrode, via a storage capacitance 24 which may be a separately formed capacitor or the intrinsic gate—source capacitance of the transistor. The gate of the drive transistor 30 is also connected via a switch 39 to its drain terminal.

The transistor circuit operates in the manner of a single transistor current mirror with the same transistor performing both current sampling and current output functions and with the display element 2 acting as the load.

An input to this current mirror circuit is provided by the input line 6 which connects to a node 44 between the drive transistor 30 and the switch 33, via a further switch 46 which controls the application of an input signal to the node.

Operation of the circuit takes place in two phases. In a first, sampling, phase, corresponding in time to an addressing period, an input signal for determining a required output from the display element is drained from the circuit and a consequential gate—source voltage on the drive transistor 30 is sampled and stored in the capacitance 24. In a subsequent, output, phase the drive transistor 30 operates to draw current through the display element 2 according to the level of the stored voltage so as to produce the required output from the display element, as determined by the input signal, which output is maintained for example until the display element is next addressed in a subsequent, new, sampling phase. During both phases it is assumed that the supply lines 26 and 34 are at appropriate, pre-set, potential levels, V1 and V2. In this configuration, the supply line 26 will normally be at a positive potential (V1) and the supply line 34 will be at ground (V2).

During the sampling phase, the switches 39 and 46 are closed, which diode—connects the drive transistor 30, and couples the input 6 to the node 44. The switch 33 is open, which isolates the display element load. An input signal, corresponding to the required display element current and denoted here as Iin, is driven through the drive transistor 30 from an external source, e.g. the column driver circuit 9 in FIG. 1, via the input line 6, the closed switch 46 and the input terminal 44. Because the drive transistor 30 is diode—connected by virtue of the closed switch 39, the voltage across the capacitance 24 at the steady state condition will be the gate—source voltage that is required to drive a current Iin through the channel of the drive transistor 30. Having allowed sufficient time for this current to stabilise, the sampling phase is terminated upon the opening of the switches 39 and 46, isolating the input terminal 44 from the input line 6 and isolating the capacitance 24 so that the gate—source voltage, for the drive transistor determined in accordance with the input signal Iin, is stored in the capacitance 24.

The output phase then begins upon the closing of the switch 33, thus connecting the display element anode to the drain of the drive transistor 30. The drive transistor 30 then operates as a current source and a current approximately equal to Iin is drawn through the display element 2.

Because the same transistor is used to sample Iin during the sampling phase and to generate the current during the output phase, the display element current is not dependent on the threshold voltage or the mobility of the transistor 30.

There is increasing interest in the use of current-addressed pixels, and the invention concerns such current-addressed displays.

One advantage of the use of LPTS technology (rather than current amorphous silicon technology) is the ability to form row and/or column driver circuitry on the same substrate and using the same technology as the active matrix display substrate. For calibrated current-addressed displays, which are suitable for overcoming in-pixel variations as discussed above, the column driver is required to source accurate currents to the pixel columns. The mobility characteristic variations of the LPTS TFTs can then present a particular problem when implementing the column driver circuitry using LPTS TFTs, depending on the type of driver circuit.

In a driver circuit using voltage addressed LTPS TFTs, these mobility characteristic variations cause a proportional change in the drain-source current for a given gate voltage above threshold, and this is difficult to correct.

As the number of column driver circuits is far fewer than the number of pixels, and each column driver circuit has an effect on a full column of pixels, accurate correction of TFT characteristics for the TFTs used in an integrated column driver circuit is appropriate.

According to the invention, there is provided a display device comprising an array of current-addressed display pixels and driver circuitry for providing pixel drive currents to the pixels of the array, wherein the driver circuitry comprises a plurality of current drive circuits, each having an output transistor arrangement, wherein the output transistor arrangement comprises a plurality of output transistors in parallel, and wherein within each current drive circuit, one or more of the output transistors can be selected in order to provide desired output characteristics.

In this arrangement, the output of each drive circuit can be tuned to provide the required output characteristics. As each current drive circuit is for a column of pixels, the number of drive circuits required is low (compared to the number of pixels) and there is space to provide the multiple output transistor arrangement.

The current drive circuits are preferably at least partially integrated onto the substrate of the array of display pixels. In particular, the output transistors are integrated onto the substrate. The display pixels may comprise active matrix display pixels, each comprising a pixel circuit having at least one thin film transistor, for example a polysilicon TFT. The output transistors then comprise polysilicon TFTs, for example low temperature polysilicon TFTs.

Alternatively, the drive circuit TFTs could be present, or prepared, on a separate substrate, but made with the same TFT technology (for example LTPS) as the display pixels. A substrate transfer process can be employed in such a case.

One or more of the output transistors can be selected by breaking a fusible link thereby to disconnect the non-selected output transistors. In this way, the desired output transistors remain in circuit.

In one arrangement, one of the output transistors can be a main output transistor (which is always in circuit) and the others are fine tuning transistors having smaller channel width/length ratios than the main output transistor. For example, the channel width/length ratio of each fine tuning transistor is less than 1/25 of the width/length ratio of the main output transistor.

In an alternative arrangement, only one of the output transistors is selected, and the channel width/length ratios of all of the output transistors are substantially the same, for example varying by less than 10%.

In another alternative arrangement, one or more of the output transistors can be selected by electrically connecting them into circuit, for example using further switches which either connect their gate to a common gate control line for the current drive circuit or to a deselect line.

Preferably, the current-addressed display pixels comprise electroluminescent display pixels.

The invention also provides a method of tuning driver circuitry for providing pixel drive currents to the pixels of a display device having an array of current-addressed display pixels, the driver circuitry comprising a plurality of current drive circuits, the method comprising:

providing each current drive circuit with an output transistor arrangement comprising a plurality of output transistors in parallel;

selecting one or more of the output transistors to provide desired output characteristics for the current drive circuit.

The selection may be performed based on an analysis of the output characteristics of the display device for a given default selection of the output transistors. For example, image sensing of the light output of the display may be carried out.

The invention will now be described by way of example with reference to the accompanying drawings, in which:

FIG. 1 shows a known EL display device;

FIG. 2 is a schematic diagram of a known pixel circuit for current-addressing the EL display pixel using an input drive voltage;

FIG. 3 is a schematic diagram of a known pixel circuit for current-addressing the EL display pixel using an input drive current;

FIG. 4 shows one example of known column driver circuit for an EL device which can be modified by the invention

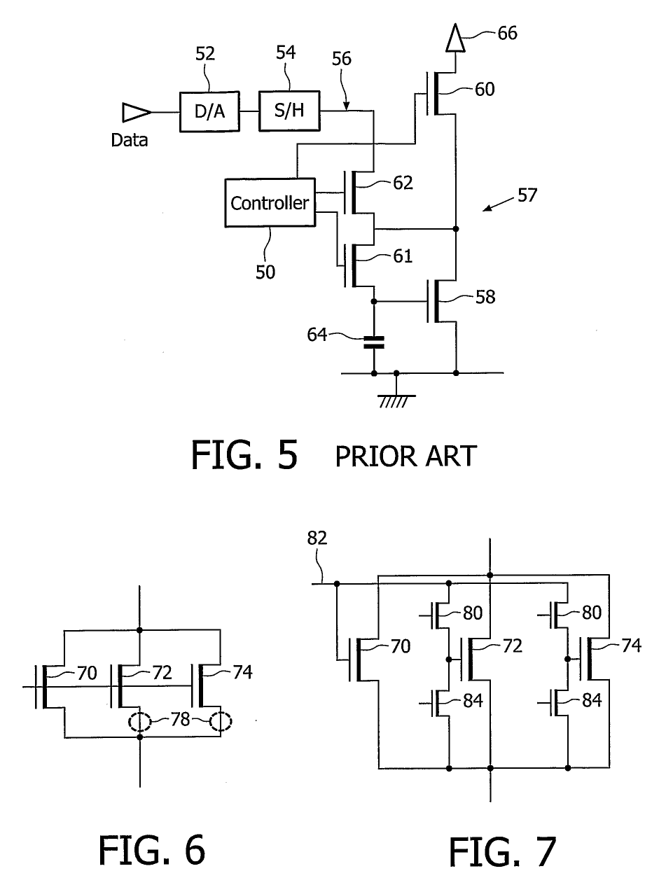

FIG. 5 shows another example of known column driver circuit for an EL device which can be modified by the invention;

FIG. 6 is used to explain one implementation of the invention; and

FIG. 7 is used to explain another implementation of the invention.

The same reference numerals are used in different figures for the same components, and description of these components will not be repeated.

The invention provides driver circuitry for providing pixel drive currents to the pixels of a display. An output transistor arrangement for each column drive circuit has a plurality of output transistors in parallel, and one or more of these are selected in order to provide desired output characteristics. Thus, the output of each column drive circuit can be tuned to provide the required output characteristics.

Before describing the invention in detail, two examples of known column driver circuit for a current addressed display will be described.

A first example of column driver circuit uses voltage-controlled current source circuits to generate the required currents for addressing the pixel columns. Each current source circuit can essentially take the form of the pixel circuit of FIG. 2, in which a control voltage is applied to the gate of a current source transistor. FIG. 4 shows an example of a voltage controlled current source column driver circuit.

As shown in FIG. 4, a drive transistor 47 has an analogue voltage 48 applied to its gate, preferably through a multiplexer circuit 49. The driver circuit of FIG. 4 performs a sample and hold function, and the capacitor C may be required for this purpose. The sample and hold capability enables multiplexing of the analogue signals in the driver circuit.

This circuit can be provided on the same substrate as the pixel array, and thus provides voltage to current conversion on the glass substrate. The control voltages can be generated off the substrate, for example on a silicon IC, and are then provided to the substrate.

The threshold voltage variations and mobility variations will influence the output characteristics of the voltage-current conversion circuit.

In a second example of column driver circuit, currents can be generated in a separate IC so that the column driver acts as a current sample and hold circuit rather than a voltage to current converter.

For example, each column can be connected to a current mirror drive circuit forming part of the column driver. This operates to duplicate or amplify a reference current provided to the circuit from a sample and hold circuit.

FIG. 5 shows a data input being applied to a D/A converter 52 and a sample and hold circuit 54, which provides and stores an analogue current which corresponds to the desired pixel drive current. This would take place outside the substrate, so that currents rather than voltages are provided to the substrate. The sample and hold function may of course be performed by the capacitances within the circuit, in which case the circuit 54 may not be required.

In this case, each column driver circuit has a current mirror circuit 57, one of which is shown in FIG. 5.

There are numerous possible current source circuit designs. The output circuit may simply act as a current mirror or else the output stage can amplify the sample and hold circuit current output.

FIG. 5 shows a simple output stage with no amplification. The output TFT 58 provides the current driving function. A column TFT 60 controls the connection of the column to the current mirror drive circuit, and applies the current to the column. Control TFTs 61, 62 and the column TFT 60 are controlled by a controller 50.

In this circuit, the input current 56 from the sample and hold circuit causes a storage capacitor 64 to charge, and the capacitor stores the gate-source voltage of the output TFT 58. Charging of the capacitor 64 turns on the output TFT 58. An equilibrium is reached when the voltage on the capacitor 64 is such that the input current is sunk entirely by the output TFT 58. The capacitor 64 will be charged no further and the transistor 61 can be turned off. Thus, the input current is sampled by the output TFT 58.

When the column TFT 60 is turned on, the output TFT 58 delivers/draws the previously sampled current from the pixel column 66. Thus, the circuit has a calibration phase and a current delivery phase.

In this example of current mirror circuit, the output is provided by the output TFT 58. Although threshold and mobility variations have less effect than in the single transistor voltage-current converter of FIG. 4, there are second order effects which again give rise to different drive characteristics for different columns.

Many different types of current drive circuits are possible. However, whether these are voltage driven or current sampling, they will still typically have a main current providing TFT at the output of the circuit, and this invention is directed specifically to these current-providing output TFTs within column address circuitry.

FIG. 6 shows one example of output transistor arrangement of the invention, for replacing the output TFT 58 of FIG. 5 or the current-source drive transistor 47 of FIG. 4.

As shown, the output transistor arrangement comprises a plurality of output transistors 70, 72, 74 in parallel. One or more of the output transistors can be selected in order to provide the desired output characteristics.

This tunability enables LTPS transistors to be used in the column current driver circuits, so that integration onto the substrate of the array of display pixels is possible.

Alternatively, the drive circuit TFTs could be present, or prepared, on a separate substrate, but made with the same TFT technology (for example LTPS) as the display pixels.

The variation in mobility to be corrected has a similar effect to varying the channel width/length ratio of a transistor, and the use of parallel connected transistors enables the effective width/length ratio of the output transistor arrangement to be trimmed for compensating for mobility variations.

In FIG. 6, the transistor 70 is a main output transistor, and is always connected. The other two transistors 72, 74 have fusible links 78 which can be burned out using a laser, thereby disconnecting the non-selected output transistors. The desired output transistors then remain in parallel in circuit.

The transistors 70, 72, 74 can have channel width/length ratios in the ratio 100:2:1 (for example), so that one of the output transistors is a main output transistor and the others are fine tuning transistors. Of course, increased tuning accuracy can be achieved by having more transistors in parallel.

In an alternative arrangement, only one of the output transistors is selected, and the channel width/length ratios of all of the output transistors are substantially the same, for example varying by less than 10%. In this case, all of the transistors will be associated with a fusible link.

Instead of using fusible links, a further transistor could be used as a switch in the place of a fusible link in series with the output transistors.

In an alternative arrangement shown in FIG. 7, the output transistors can selected by electrically connecting them into circuit, for example using further switches 80 which connect the gates of the output transistors to a common gate control line 82, or using further switches 84 which connect the gates of the output transistors to a deselect line, for example the source in FIG. 6, as the transistor will be turned off with shorted gate and source, or any convenient bias line. The transistor switches 80 and 84 could also be implemented as fusible links.

In order to determine the appropriate calibration of each column driver output stage, a feedback system is required. In one preferred implementation, this is achieved based on an analysis of the output characteristics of the display device for a given (default) selection of the output transistors.

For example, the light output of the display may be provided to an image sensor panel (typically a CCD array), with all pixels illuminated. This can be carried out for all three colours of a colour display.

The integral brightness for each column is determined and this is used to determine differences in the column driver outputs. This will be carried out before any fusible links are broken, or for an electronically controlled implementation, for the same configuration of the output transistor arrangement. The differences in column outputs detected are then used to derive a correction scheme, which selects the desired output transistor configuration for each column driver circuit.

Alternatively, it may be possible to probe the display to measure the current output of the drive transistor being tested.

There are numerous different possible column driver circuits for providing controllable currents to the pixel columns.

The column current drive circuits may function as current sources or current sinks. Although the preferred use of the invention is in OLED (organic light emitting diode) displays, the invention can be used in other current-addressed displays.

Various other modifications will be apparent to those skilled in the art

1. A display device comprising an array of current-addressed display pixels (1) and driver circuitry for providing pixel drive currents to the pixels of the array, wherein the driver circuitry comprises a plurality of current drive circuits, each having an output transistor arrangement, wherein the output transistor arrangement comprises a plurality of output transistors (70,72,74) in parallel, and wherein within each current drive circuit, one or more of the output transistors (70,72,74) can be selected in order to provide desired output characteristics.

2. A device as claimed in claim 1, wherein the current drive circuits are at least partially integrated onto the substrate of the array of display pixels.

3. A device as claimed in claim 2, wherein the display pixels comprise active matrix display pixels, each comprising a pixel circuit having at least one thin film transistor (22).

4. A device as claimed in claim 3, wherein the thin film transistor (22) comprises a polysilicon TFT, and wherein the output transistors comprise polysilicon TFTs on the same substrate as the display pixels.

5. A device as claimed in claim 4, wherein the thin film transistor (22) and the output transistors (70,72,74) comprise low temperature polysilicon TFTs.

6. A device as claimed where the output transistors of the current drive circuits are made in the same process as the array of current-addressed display pixels but on a different substrate.

7. A device as claimed in claim 1, wherein one or more of the output transistors are selected by breaking a fusible link (78) thereby to disconnect the non-selected output transistors.

8. A device as claimed in claim 1, wherein one or more of the output transistors (70,72,74) are selected by electrically connecting them in parallel.

9. A device as claimed in claim 8, wherein one or more of the output transistors are selected by further switches (80,84) which either connect their gate to a common gate control line (82) for the current drive circuit or to a deselect line.

10. A device as claimed in claim 7, wherein one of the output transistors (70) is a main output transistor and the others (72,74) are fine tuning transistors having smaller channel widths than the main output transistor.

11. A device as claimed in claim 10, wherein the channel width/length ratio of each fine tuning transistor (72,74) is less than 1/25 of the width/length ratio of the main output transistor (70).

12. A device as claimed in claim 7, wherein only one of the output transistors (70,72,74) is selected, and the channel width/length ratios of all of the output transistors vary by less than 10%.

13. A device as claimed in claim 1, wherein the current-addressed display pixels comprise electroluminescent display pixels.

14. A device as claimed in claim 13, wherein the current-addressed display pixels each comprise an organic LED.

15. A method of tuning driver circuitry for providing pixel drive currents to the pixels of a display device having an array of current-addressed display pixels, the driver circuitry comprising a plurality of current drive circuits, the method comprising:
providing each current drive circuit with an output transistor arrangement comprising a plurality of output transistors (70,72,74) in parallel;
selecting one or more of the output transistors (70,72,74) to provide desired output characteristics for the current drive circuit.

16. A method as claimed in claim 15, wherein the selection is performed based on an analysis of the output characteristics of the display device for a given default selection of the output transistors (70,72,74).

17. A method as claimed in claim 16, wherein the analysis of the output characteristics is performed by monitoring the light output of the display using an image sensor and analysing the sensed image.

18. A method as claimed in claim 16, wherein the selection comprises breaking a fusible link (78) thereby to disconnect the non-selected output transistors.

19. A method as claimed in claim 18, wherein one of the output transistors (70) is a main output transistor and the others are fine tuning transistors (72,74) having smaller channel width/length ratios than the main output transistor, and the method comprises selecting the main output transistor (70) and 0, 1 or more of the fine tuning transistors (72,74).

20. A method as claimed in claim 18, wherein the channel width/length ratios of all of the output transistors vary by less than 10%, and the method comprises selecting only one of the output transistors (70,72,74).

21. A method as claimed in claim 16, wherein the selection comprises electrically connecting the selected transistors in parallel.
